(19) United States
(12) Patent Application Publication
(10) Pub. No.: US 2025/0344302 A1
(43) Pub. Date: Nov. 6, 2025

(54) CONTROL DEVICE AND ILLUMINATION DEVICE

(71) Applicant: Japan Display Inc., Tokyo (JP)

(72) Inventor: Shouhei ITOU, Tokyo (JP)

(21) Appl. No.: 19/264,396

(22) Filed: Jul. 9, 2025

Related U.S. Application Data
(63) Continuation of application No. PCT/JP2023/044405, filed on Dec. 12, 2023.

(30) Foreign Application Priority Data
Jan. 31, 2023 (JP) 2023-013322

(51) Int. Cl. H05B 45/325; H05B 45/10; H05B 45/20

(52) U.S. Cl. CPC H05B 45/325; H05B 45/10; H05B 45/20

(57) ABSTRACT

A control device includes an oscillation circuit for outputting a first pulse voltage, an integration circuit electrically connected to the oscillation circuit for converting the first pulse voltage into a triangular wave voltage and outputting the voltage, a comparison circuit electrically connected to the integration circuit for comparing the triangular wave voltage with a threshold voltage and outputting a second pulse voltage, an inverter electrically connected to the comparison circuit for outputting a third pulse voltage obtained by inverting the second pulse voltage, a first variable resistor electrically connected to the comparison circuit for adjusting the threshold voltage input to the comparison circuit, and a drive circuit for generating a first pulse signal to be input to a first light emitting element based on the second pulse voltage and a second pulse signal to be input to a second light emitting element based on the third pulse voltage.

### CROSS-REFERENCE TO RELATED APPLICATIONS

This application is a Continuation of International Patent Application No. PCT/JP2023/044405, filed on Dec. 12, 2023, which claims the benefit of priority to Japanese Patent Application No. 2023-013322, filed on Jan. 31, 2023, the entire contents of which are incorporated herein by reference.

### FIELD

An embodiment of the present invention relates to a control device for controlling the color adjustment or dimming of a light source. Further, an embodiment of the present invention relates to an illumination device capable of controlling the color adjustment or dimming of a light source.

### BACKGROUND

In an illumination device, a control method is known in which the dimming of illumination is controlled based on a control signal transmitted from an information terminal (for example, see Japanese laid-open patent publication No. 2018-37986).

### SUMMARY

A control device according to an embodiment of the present invention is a control device for controlling a light source including a first light emitting element having a first emission color and a second light emitting element having a second emission color different from the first emission color. The control device includes an oscillation circuit for outputting a first pulse voltage, an integration circuit electrically connected to the oscillation circuit for converting the first pulse voltage into a triangular wave voltage and outputting the voltage, a comparison circuit electrically connected to the integration circuit for comparing the triangular wave voltage with a threshold voltage and outputting a second pulse voltage, an inverter electrically connected to the comparison circuit for outputting a third pulse voltage obtained by inverting the second pulse voltage, a first variable resistor electrically connected to the comparison circuit for adjusting the threshold voltage input to the comparison circuit, and a drive circuit for generating a first pulse signal to be input to the first light emitting element based on the second pulse voltage and a second pulse signal to be input to the second light emitting element based on the third pulse voltage.

An illumination device according to an embodiment of the present invention includes a light source including a first light emitting element having a first emission color and a second light emitting element having a second emission color different from the first emission color, an optical element including a plurality of liquid crystal cells that transmits irradiated light from the light source to control a light distribution, and a control device connected to the light source and controlling the first light emitting element and the second light emitting element. The control device includes an oscillation circuit for outputting a first pulse voltage, an integration circuit electrically connected to the oscillation circuit for converting the first pulse voltage into a triangular wave voltage and outputting the voltage, a comparison circuit electrically connected to the integration circuit for comparing the triangular wave voltage with a threshold voltage and outputting a second pulse voltage, an inverter electrically connected to the comparison circuit for outputting a third pulse voltage obtained by inverting the second pulse voltage, a first variable resistor electrically connected to the comparison circuit for adjusting the threshold voltage input to the comparison circuit, and a drive circuit for generating a first pulse signal to be input to the first light emitting element based on the second pulse voltage and a second pulse signal to be input to the second light emitting element based on the third pulse voltage. The first pulse signal is input to the first light emitting element. The second pulse signal is input to the second light emitting element.

### BRIEF DESCRIPTION OF DRAWINGS

FIG. 1 is a schematic diagram showing a configuration of an illumination device according to an embodiment of the present invention.

FIG. 2 is a schematic diagram showing a configuration of a light source of an illumination device according to an embodiment of the present invention.

FIG. 3 is a block diagram showing a configuration of a power supply device and a second control device of an illumination device according to an embodiment of the present invention.

FIG. 4 is a circuit diagram showing a part of a circuit configuration of a control device of an illumination device according to an embodiment of the present invention.

FIG. 5 is a schematic diagram illustrating a first pulse signal and a second pulse signal output from a second control device of an illumination device according to an embodiment of the present invention.

### DESCRIPTION OF EMBODIMENTS

An illumination device controlled using an information terminal requires a control circuit including a microcomputer and a digital-to-analog converter (DAC) that occupies a large area. The microcomputer is expensive, and the manufacturing cost increases as the number of DACs increases. Therefore, there has been a demand for a reduction in the manufacturing cost of a control device that controls the dimming or color adjustment of an illumination device.

In view of the above problems, an embodiment of the present invention can provide a control device for a light source, which can be manufactured at reduced costs. Further, an embodiment of the present invention can provide an illumination device, which can be manufactured at reduced costs.

In the following description, each of the embodiments of the present invention is described with reference to the drawings. However, the present invention can be implemented in various modes without departing from the gist of the invention and should not be interpreted as being limited to the description of the embodiments exemplified below.

Although the drawings may be schematically represented in terms of width, thickness, shape, and the like of each part as compared with their actual mode in order to make explanation clearer, they are only an example and an interpretation of the present invention is not limited. In addition, in the drawings, the same reference numerals are provided to the same elements as those described previously with reference to preceding figures and repeated explanations may be omitted accordingly.

In the case when a single film is processed to form a plurality of structural bodies, each structural body may have different functions and roles, and the bases formed beneath each structural body may also be different. However, the plurality of structural bodies is derived from films formed in the same layer by the same process and have the same material. Therefore, the plurality of these films is defined as existing in the same layer.

When expressing a mode in which another structure is arranged over a certain structure, in the case where it is simply described as “over”, unless otherwise noted, a case where another structure is arranged directly over a certain structure as if in contact with that structure, and a case where another structure is arranged via yet another structure over a certain structure, are both included.

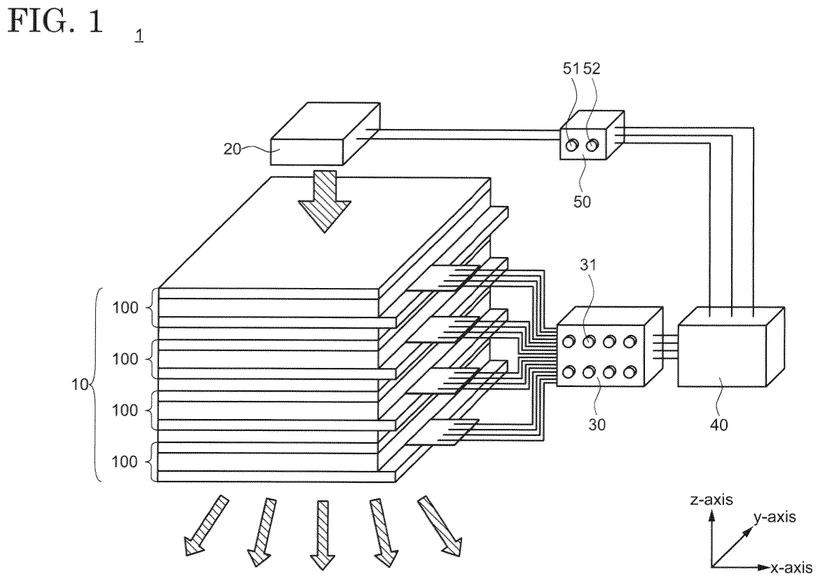

An illumination device 1 according to an embodiment of the present invention is described with reference to FIGS. 1 to 5. In addition, although a configuration of the illumination device 1 is described below as an embodiment of the present invention, the embodiment of the present invention is not limited to the illumination device 1. A part of the components of the illumination device 1 may constitute an embodiment of the present invention.

### 1. Configuration of Illumination Device 1

FIG. 1 is a schematic diagram showing a configuration of the illumination device 1 according to an embodiment of the present invention. As shown in FIG. 1, the illumination device 1 includes an optical element 10, a light source 20, a first control device 30, a power supply device 40, and a second control device 50. The first control device 30 and the second control device 50 are control devices for the optical element 10 and the light source 20, respectively. In the illumination device 1, light emitted from the light source 20 passes through the optical element 10 and is emitted from the optical element 10. At this time, the light source 20 is controlled by the second control device 50 to change the light emitted from the light source 20. Further, the optical element 10 is controlled by the first control device 30 to change the light passing through the optical element 10. Specifically, the second control device 50 controls the color adjustment or dimming, and the first control device 30 controls the light distribution.

### 2. Configuration of Optical Element 10 and First Control Device 30

The optical element 10 includes four liquid crystal cells 100 stacked in a z-axis direction. Although not shown in the figures, the liquid crystal cell 100 has a configuration in which a liquid crystal is sealed between two glass substrates on which transparent electrodes are formed in a comb-like shape. When a potential difference is applied between adjacent transparent electrodes on the glass substrates, the orientation of the liquid crystal molecules changes. As a result, a refractive index distribution occurs in the liquid crystal, and the transmitted light is diffused accordingly. This changes the distribution (shape or angle) of the light passing through the liquid crystal. The first control device 30 generates a voltage signal to be applied to the transparent electrodes of the liquid crystal cells 100. In addition, although FIG. 1 shows the optical element 10 including four liquid crystal cells 100, the number of liquid crystal cells 100 is not limited to four. The optical element 10 only needs to include at least two liquid crystal cells 100.

The first control device 30 is connected to the four liquid crystal cells 100 of the optical element 10 and controls each liquid crystal cell 100 of the optical element 10. Specifically, the first control device 30 generates a voltage signal according to the light distribution. The first control device 30 is provided with eight volume knobs 31 that can be rotated by a user. By changing the combination of the rotations of the eight volume knobs 31 and the rotation angles of each of the eight volume knobs 31, the voltage signal applied to the transparent electrodes of each liquid crystal cell 100 can be adjusted. In other words, the volume knobs 31 can adjust the light distribution of the light emitted from the optical element 10. Although the eight volume knobs 31 with two volume knobs 31 assigned to control one liquid crystal cell 100 are shown in FIG. 1, the number of volume knobs 31 is not limited to eight. The volume knobs 31 may be of a sliding type instead of a rotating type.

### 3. Configuration of Power Supply Device 40

The power supply device 40 is connected to the first control device 30 and the second control device 50, and generates a power supply voltage required to drive the first control device 30 and the second control device 50. The power supply device 40 may generate a plurality of power supply voltages. The power supply device 40 may also include a power supply voltage that is GND (e.g., 0 V). In addition, in the present specification, an explanation may be provided describing that a power supply voltage is generated even in the case of GND, for convenience.

In addition, although FIG. 1 shows one power supply device 40, the power supply device 40 may be separated into a power supply device that generates a power supply voltage to be supplied to the first control device 30 and a power supply device that generates a power supply voltage to be supplied to the second control device 50. Further, the power supply device 40 may be integrated with the first control device 30 or the second control device 50.

### 4. Configuration of Light Source 20 and Second Control Device 50

The light source 20 is disposed over the optical element 10 and emits light to the optical element 10. Although light emitting diodes (LEDs) can be used for the light source 20, for example, the light source 20 is not limited thereto. The light source 20 may be any element or device that can emit light.

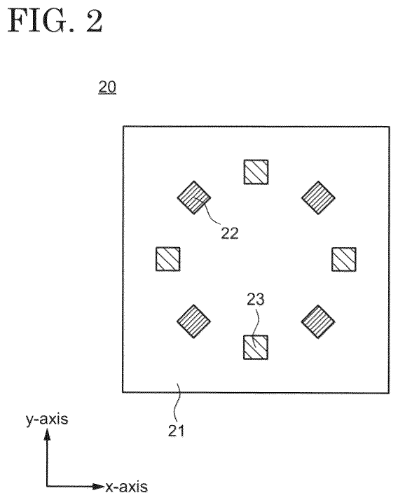

A configuration of the light source 20 is described in detail with reference to FIG. 2

FIG. 2 is a schematic diagram showing a configuration of the light source 20 of the illumination device 1 according to an embodiment of the present invention. FIG. 2 shows the configuration in which light emitting diodes are used as an example of the light source 20.

As shown in FIG. 2, the light source 20 includes a base 21, a first light emitting element 22, and a second light emitting element 23. The first light emitting element 22 and the second light-emitting element 23 are light emitting diodes. A plurality of first light emitting elements 22 and a plurality of second light emitting elements 23 are arranged on the base 21. A first pulse signal generated by the second control device 50 is input to each of the plurality of first light emitting elements 22. Further, a second pulse signal generated by the second control device 50 is input to each of the plurality of second light emitting elements 23. In the illumination device 1, the color adjustment or dimming of the light source 20 can be controlled based on the first pulse signal and the second pulse signal. The first pulse signal and the second pulse signal are described later.

The first light emitting elements 22 and the second light emitting elements 23 are alternately arranged to form a circular shape. However, the arrangement of the first light emitting elements 22 and the second light emitting elements 23 is not limited thereto. It is preferable that the first light emitting elements 22 and the second light emitting elements 23 are symmetrically arranged so that the light emitted from the light source 20 is uniformly incident on the optical element 10. In addition, although it is preferable that the number of the first light emitting elements 22 and the second light emitting elements 23 is more than one, the number of the first light emitting elements 22 and the second light emitting elements 23 is not limited thereto. The number of the first light emitting elements 22 and the second light emitting elements 23 may be one. Further, the number of the first light-emitting elements 22 and the number of the second light emitting elements 23 may be the same or different from each other.

The first light emitting element 22 has a first light emitting color. The second light emitting element 23 has a second light emitting color different from the first light emitting color. For example, the light source 20 can emit white light by combining the first light emitting element 22 that emits blue light with the second light emitting element 23 that emits yellow light. The first light emitting element 22 having the first light emitting color and the second light emitting element 23 having the second light emitting color may be combined so that light having a warm white (color temperature 3000 K), a natural white (color temperature 5000 K), or a daylight color (color temperature 6500 K) is emitted from the light source 20. The second light emitting element 23 may have a configuration in which the first light emitting element 22 is provided with a phosphor and the first light emitting color is converted into the second light emitting color by the phosphor. The light source 20 can be configured in a manner other than white light, and the first light emitting color and the second light emitting color are not particularly limited thereto.

Although not shown in the figures, a reflector may be provided on the inner side surface of the base 21. In this case, the light emitted from the first light emitting element 22 and the second light emitting element 23 is reflected by the reflector and emitted from the light source 20. Therefore, the amount of light incident on the optical element 10 increases.

Returning to FIG. 1, the configuration of the second control device 50 is described. The second control device 50 is connected to the light source 20 and controls the first light emitting element 22 and the second light emitting element 23 of the light source 20. Specifically, the second control device 50 generates the first pulse signal input to the first light emitting element 22 and the second pulse signal input to the second light emitting element 23 according to color adjustment or dimming. The second control device 50 is provided with a first volume knob 51 and a second volume knob 52 that can be rotated by a user. The color adjustment of the light source 20 can be controlled by adjusting the rotation angle of the first volume knob 51. Further, the dimming of the light source 20 can be controlled by adjusting the rotation angle of the second volume knob 52. In addition, the first volume knob 51 and the second volume knob 52 may be of a sliding type instead of a rotating type.

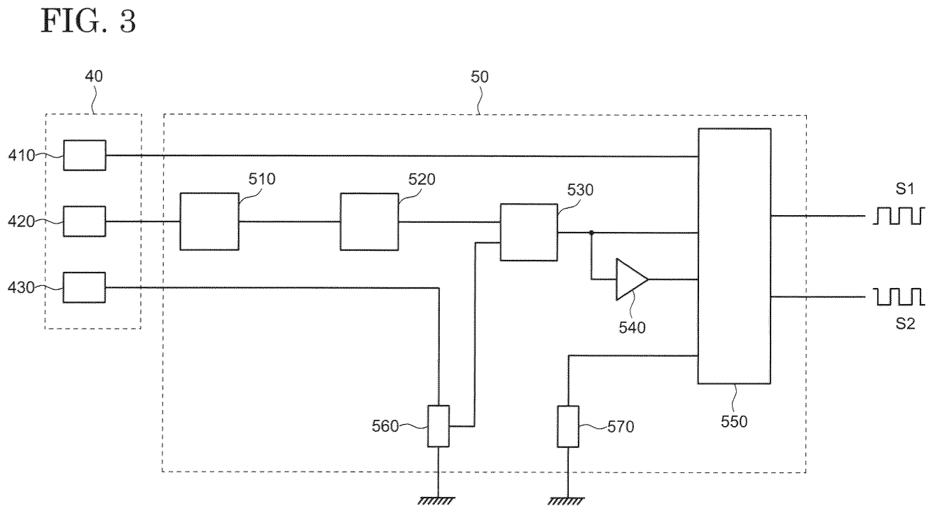

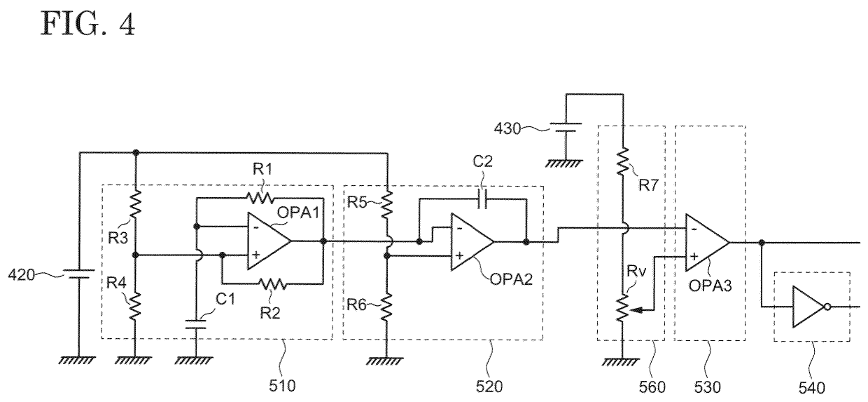

The configuration of the second control device 50 is described in further detail with reference to FIGS. 3 and 4.

FIG. 3 is a block diagram showing a configuration of the power supply device 40 and the second control device 50 of the illumination device 1 according to an embodiment of the present invention.

As shown in FIG. 3, the power supply device 40 includes a first power supply 410, a second power supply 420, and a third power supply 430. Further, the second control device 50 includes an oscillation circuit 510, an integration circuit 520, a comparison circuit 530, an inverter 540, a drive circuit 550, a first variable resistor 560, and a second variable resistor 570. The first volume knob 51 is connected to the first variable resistor 560, and the resistance of the first variable resistor 560 changes when a user rotates the first volume knob 51. The second volume knob 52 is connected to the second variable resistor 570, and the resistance of the second variable resistor 570 changes when a user rotates the second volume knob 52.

The first power supply 410 is electrically connected to the drive circuit 550 and supplies a power supply voltage for driving the drive circuit 550. The second power supply 420 is electrically connected to the oscillation circuit 510 and supplies a power supply voltage for the oscillation circuit 510 to generate a pulse voltage. The third power supply 430 is electrically connected to the first variable resistor 560 and supplies a power supply voltage for generating a threshold voltage to be input to the comparison circuit 530.

The oscillation circuit 510 generates and outputs a first pulse voltage. The oscillation circuit 510 is electrically connected to the integration circuit 520, and the first pulse voltage output from the oscillation circuit 510 is input to the integration circuit 520.

The integration circuit 520 converts the first pulse voltage into a triangular wave voltage and outputs the triangular wave voltage. The integration circuit 520 is electrically connected to the comparison circuit 530, and the triangular wave voltage output from the integration circuit 520 is input to the comparison circuit 530.

The comparison circuit 530 is connected to the integration circuit 520 and the first variable resistor 560. Not only the triangular wave voltage from the integration circuit 520 but also the threshold voltage from the first variable resistor 560 are input to the comparison circuit 530. The comparison circuit 530 compares the triangular wave voltage with the threshold voltage to generate a second pulse voltage. Specifically, the comparison circuit 530 generates the second pulse voltage that includes an on-period when the triangular wave voltage is greater than or equal to the threshold voltage and an off-period when the triangular wave voltage is less than the threshold voltage. The threshold voltage varies depending on the resistance of the first variable resistor 560. Therefore, the on-period of the second pulse voltage can be controlled by adjusting the resistance of the first variable resistor 560. That is, the second pulse voltage is a PWM (Pulse Width Modulation) voltage in which the on-period and the off-period are controlled. The duty ratio of the on-period in the second pulse voltage is determined by the threshold voltage.

The comparison circuit 530 outputs the second pulse voltage and a third pulse voltage obtained by inverting the phase of the second pulse voltage by the inverter 540. The on-period of the third pulse voltage corresponds to the off-period of the second pulse voltage. The comparison circuit 530 and the inverter 540 are electrically connected to the drive circuit 550, and the second pulse voltage and the third pulse voltage are input to the drive circuit 550.

The driving circuit 550 is electrically connected to the comparison circuit 530, the inverter 540, and the second variable resistor 570. The driving circuit 550 converts the second pulse voltage and the third pulse voltage into a first pulse signal S1 for driving the first light emitting element 22 and a second pulse signal S2 for driving the second light emitting element 23, respectively. The first pulse signal S1 and the second pulse signal S2 are generated based on the second pulse voltage and the third pulse voltage, respectively. At this time, the amplitudes of the first pulse signal S1 and the second pulse signal S2 change depending on the resistance of the second variable resistor 570. That is, the amplitudes of the first pulse signal S1 and the second pulse signal S2 can be controlled by adjusting the resistance of the second variable resistor 570.

The first light emitting element 22 to which the first pulse signal S1 is input can emit light only during the on-period corresponding to the duty ratio. The second light emitting element 23 to which the second pulse signal S2 is input can be similarly controlled. That is, the light source 20 including the first light emitting element 22 and the second light emitting element 23 is controlled by PWM driving. When the duty ratio is changed, the light emission period of the first light emitting element 22 and the light emission period of the second light emitting element 23 change, and the color of the light emitted from the light source 20 changes. Further, when the amplitude of each of the first pulse signal S1 and the second pulse signal S2 is changed, the brightness of each of the first light emitting element 22 and the second light emitting element 23 changes. In this way, the second control device 50 can generate the first pulse signal S1 and the second pulse signal S2 that control the color adjustment and dimming of the light source 20.

Although a circuit configuration of the second control circuit 500 is described with reference to FIG. 4, the oscillator circuit 510, the integrator circuit 520, and the comparator circuit 530 are mainly described in the following description. In the second control circuit 500, a circuit configuration using an operational amplifier is applied, so that expensive components such as a microcomputer or a DAC are not required. Therefore, the manufacturing cost of the illumination device 1 can be reduced.

FIG. 4 is a circuit diagram showing a part of the circuit configuration of the second control circuit 50 of the illumination device 1 according to an embodiment of the present invention. In addition, FIG. 4 is an example of the circuit configuration of the second control circuit 500, and the circuit configuration of the second control circuit 500 is not limited thereto. Further, FIG. 4 omits power supply connections and the like that would be understandable to a person skilled in the art.

The oscillation circuit 510 includes a first operational amplifier OPA1. In the first operational amplifier OPA1, an inverting input terminal (−) is connected to an output terminal via a resistive element R1. Further, the inverting input terminal (−) is connected to a capacitive element C1. On the other hand, a non-inverting input terminal (+) is connected to an output terminal via a resistive element R2. Further, the non-inverting input terminal (+) is connected to a second power supply 420 via a resistive element R3, and is connected to GND via a resistive element R4. The resistive elements R1 and R2 function as feedback resistors. The resistive elements R3 and R4 function as voltage dividing resistors. In this circuit configuration, the capacitive element C1 is charged when a HIGH voltage is output from the output terminal of the first operational amplifier OPA1, and the capacitive element C1 is discharged when a LOW voltage is output from the output terminal of the first operational amplifier OPA1. That is, the fluctuating voltage of the capacitive element C1 is input to the inverting input terminal (−) and compared with the voltage input to the non-inverting input terminal (+), so that the first pulse voltage including repeated HIGH and LOW voltages is output from the output terminal.

The integrating circuit 520 includes a second operational amplifier OPA2. In the second operational amplifier OPA2, an inverting input terminal (−) is connected to the output terminal via a capacitive element C2. Further, the inverting input terminal (−) is connected to the output terminal of the first operational amplifier OPA1, and the first pulse voltage is input to the inverting input terminal (−). On the other hand, a non-inverting input terminal (+) is connected to the second power supply 420 via a resistance element R5, and is connected to GND via a resistance element R6. The capacitive element C2 functions as a feedback resistor. The resistance elements R5 and R6 function as voltage dividing resistors. In this circuit configuration, when a HIGH voltage is input to the inverting input terminal (−), the capacitive element C2 is charged with a constant current from the inverting input terminal (−), and the voltage output from the output terminal of the second operational amplifier OPA2 decreases linearly. On the other hand, when a LOW voltage is input to the inverting input terminal (−), the opposite occurs, and the voltage output from the output terminal of the second operational amplifier OPA2 increases linearly. Therefore, when the first pulse voltage is input to the inverting input terminal (−) of the second operational amplifier OPA2, a triangular wave voltage in which the voltage repeatedly increases and decreases linearly is output from the output terminal.

The comparison circuit 530 includes a third operational amplifier OPA3. In the third operational amplifier OPA3, an inverting input terminal (−) is connected to the output terminal of the second operational amplifier OPA2, and the triangular wave voltage is input to the inverting input terminal (−). On the other hand, a non-inverting input terminal (+) is connected to the first variable resistor 560. The third power supply 430 is connected to the first variable resistor 560. Therefore, a threshold voltage according to the resistance of the first variable resistor 560 is input to the non-inverting input terminal (+). In the third operational amplifier OPA3, the triangular wave voltage input to the inverting input terminal (−) is compared with the threshold voltage input to the non-inverting input terminal (+). When the triangular wave voltage is greater than or equal to the threshold voltage, a HIGH voltage is output from the output terminal. When the triangular wave voltage is less than the threshold voltage, a LOW voltage is output from the output terminal. That is, the second pulse voltage in which a HIGH voltage and a LOW voltage are repeated is output from the output terminal of the third operational amplifier OPA3. The period of the HIGH voltage is determined by the threshold voltage. Specifically, the higher the threshold voltage, the shorter the period of the HIGH voltage, and the lower the threshold voltage, the longer the period of the HIGH voltage. Therefore, the second pulse voltage is a PWM voltage whose duty ratio can be adjusted by the threshold voltage.

For example, the first variable resistor 560 includes a resistance element R7 and a variable resistance element Rv. The resistance element R7 is connected in series with the variable resistance element Rv. The resistance element R7 functions as a fixed resistor that determines the range of the threshold voltage output through the first variable resistor 560. For example, even when the power supply voltage generated by the third power supply 430 is +15 V, the range of the threshold voltage output through the variable resistance element Rv (such as 0 to +10 V) can be adjusted by connecting the resistance element R7 to the variable resistance element Rv.

The second pulse voltage output from the output terminal of the third operational amplifier OPA3 of the comparison circuit 530 is inverted in phase by the inverter 540. The comparison circuit 530 and the inverter 540 are connected to the drive circuit 550. As a result, the second pulse voltage and a third pulse voltage in which the phase of the second pulse voltage is inverted are input to the drive circuit 550. The period of the HIGH voltage in the third pulse voltage corresponds to the period of the LOW voltage in the second pulse voltage. Therefore, the third pulse voltage is also a PWM voltage whose duty ratio is adjusted by the threshold voltage.

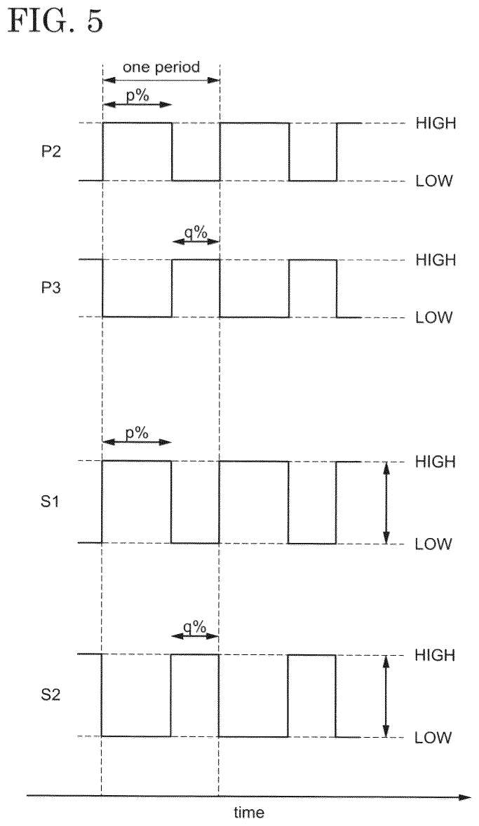

FIG. 5 is a schematic diagram illustrating the first pulse signal S1 and the second pulse signal S2 output from the second control device 50 of the illumination device according to an embodiment of the present invention. Specifically, FIG. 5 shows the second pulse voltage P2 (duty ratio p %) and the third pulse voltage P3 (duty ratio q %) whose duty ratios are adjusted and input to the drive circuit 550, as well as the first pulse signal S1 and the second pulse signal S2 output from the drive circuit 550.

In the drive circuit 550, the second pulse voltage P2 and the third pulse voltage P3 are converted into signals for driving the first light emitting element 22 and the second light emitting element 23, respectively. The first pulse signal S1 for driving the first light emitting element 22 is generated based on the second pulse voltage P2. Therefore, the first pulse signal S1 has the same duty ratio p % as the second pulse voltage P2. The second pulse signal S2 for driving the second light emitting element 23 is generated based on the third pulse voltage P3. Therefore, the second pulse signal S2 has the same duty ratio q % as the third pulse voltage P3. That is, the light source 20 including the first light emitting element 22 and the second light emitting element 23 is controlled by PWM driving.

In the light source 20, the first light emitting element 22 is driven to emit light having the first emission color during a period of a duty ratio p % in one cycle. Further, the second light emitting element 23 is driven to emit light having the second emission color during a period of a duty ratio q % in one cycle. The emission period of the first emission color and the emission period of the second emission color can be changed by adjusting each duty ratio, and the color of the light emitted from the light source 20 changes. As described above, each duty ratio is determined by the resistance of the first variable resistor 560. Therefore, in the illumination device 1, the resistance of the first variable resistor 560 can be adjusted to change the color of the light emitted from the light source 20.

Further, the second variable resistor 570 is electrically connected to the drive circuit 550. In the drive circuit 550, the amplitudes of the first pulse signal

S1 and the second pulse signal S2 change depending on the resistance of the second variable resistor 570. When the amplitude of the first pulse signal S1 increases, the brightness of the first light emitting element 22 to which the first pulse signal S1 is input increases. The same configuration is applied to the second light emitting element 23 to which the second pulse signal S2 is input. Therefore, in the illumination device 1, the brightness of the light emitted from the light source 20 can be changed by adjusting the resistance of the second variable resistor 570.

Therefore, in the illumination device 1, the color adjustment of the light source 20 can be controlled by adjusting the resistance of the first variable resistor 560 of the second control device 50, and the dimming of the light source 20 can be controlled by adjusting the resistance of the second variable resistor 570 of the second control device 50.

As described above, the illumination device 1 according to the present embodiment can control the color adjustment or dimming of the light source 20 without including expensive components such as a microcomputer and a DAC. Therefore, the manufacturing cost of the illumination device 1 can be reduced.

Within the scope of the present invention, those skilled in the art may conceive of examples of changes and modifications, and it is understood that these examples of changes and modifications are also included within the scope of the present invention. For example, additions, deletions, or design changes of constituent elements, or additions, omissions, or changes to conditions of steps as appropriate based on the respective embodiments described above are also included within the scope of the present invention as long as the gist of the present invention is provided.

Further, other effects which differ from those brought about by each embodiment, but which are apparent from the description herein or which can be readily predicted by those skilled in the art, are naturally understood to be brought about by the present invention.

What is claimed is:

1. A control device for controlling a light source including a first light emitting element having a first emission color and a second light emitting element having a second emission color different from the first emission color, comprising:
an oscillation circuit for outputting a first pulse voltage;
an integration circuit electrically connected to the oscillation circuit for converting the first pulse voltage into a triangular wave voltage and outputting the voltage;
a comparison circuit electrically connected to the integration circuit for comparing the triangular wave voltage with a threshold voltage and outputting a second pulse voltage;
an inverter electrically connected to the comparison circuit for outputting a third pulse voltage obtained by inverting the second pulse voltage;
a first variable resistor electrically connected to the comparison circuit for adjusting the threshold voltage input to the comparison circuit; and
a drive circuit for generating a first pulse signal to be input to the first light emitting element based on the second pulse voltage and a second pulse signal to be input to the second light emitting element based on the third pulse voltage.

2. The control device according to claim 1, wherein each of the oscillation circuit, the integration circuit, and the comparison circuit comprises an operational amplifier.

3. The control device according to claim 2, wherein the first variable resistor is connected to a non-inverting input terminal of the operational amplifier in the comparison circuit.

4. The control device according to claim 1, wherein each of the first light emitting element and the second light emitting element is a light emitting diode.

5. The control device according to claim 1, further comprising a second variable resistor electrically connected to the drive circuit for adjusting an amplitude of each of the first pulse signal and the second pulse signal.

6. The control device according to claim 5, wherein each of the oscillation circuit, the integration circuit, and the comparison circuit comprises an operational amplifier.

7. The control device according to claim 6, wherein the first variable resistor is connected to a non-inverting input terminal of the operational amplifier in the comparison circuit.

8. The control device according to claim 5, wherein each of the first light emitting element and the second light emitting element is a light emitting diode.

9. An illumination device, comprising:
a light source including a first light emitting element having a first emission color and a second light emitting element having a second emission color different from the first emission color;
an optical element including a plurality of liquid crystal cells that transmit irradiated light from the light source to control a light distribution; and
a control device connected to the light source and controlling the first light emitting element and the second light emitting element,
wherein the control device comprises:
an oscillation circuit for outputting a first pulse voltage;
an integration circuit electrically connected to the oscillation circuit for converting the first pulse voltage into a triangular wave voltage and outputting the voltage;
a comparison circuit electrically connected to the integration circuit for comparing the triangular wave voltage with a threshold voltage and outputting a second pulse voltage;
an inverter electrically connected to the comparison circuit for outputting a third pulse voltage obtained by inverting the second pulse voltage;
a first variable resistor electrically connected to the comparison circuit for adjusting the threshold voltage input to the comparison circuit; and
a drive circuit for generating a first pulse signal to be input to the first light emitting element based on the second pulse voltage and a second pulse signal to be input to the second light emitting element based on the third pulse voltage,
wherein the first pulse signal is input to the first light emitting element, and
wherein the second pulse signal is input to the second light emitting element.

10. The illumination device according to claim 9, wherein each of the oscillation circuit, the integration circuit, and the comparison circuit comprises an operational amplifier.

11. The illumination device according to claim 10, wherein the first variable resistor is connected to a non-inverting input terminal of the operational amplifier in the comparison circuit.

12. The illumination device according to claim 9, wherein each of the first light emitting element and the second light emitting element is a light emitting diode.

13. The illumination device according to claim 9, further comprising a second variable resistor electrically connected to the drive circuit for adjusting an amplitude of each of the first pulse signal and the second pulse signal.

14. The illumination device according to claim 13, wherein each of the oscillation circuit, the integration circuit, and the comparison circuit comprises an operational amplifier.

15. The illumination device according to claim 14, wherein the first variable resistor is connected to a non-inverting input terminal of the operational amplifier in the comparison circuit.

16. The control device according to claim 13, wherein each of the first light emitting element and the second light emitting element is a light emitting diode.
